(19) United States
(12) Patent Application Publication
(10) Pub. No.: US 2015/0076430 A1
(43) Pub. Date: Mar. 19, 2015

(54) Collapsible, Transportable, One-Man Operated Hot Water Heater Lifting Device

(71) Applicant: David Gans, Carlsbad, CA (US)

(72) Inventor: David Gans, Carlsbad, CA (US)

(21) Appl. No.: 14/284,868

(22) Filed: May 22, 2014

Related U.S. Application Data
(60) Provisional application No. 61/826,305, filed on May 22, 2013.

(51) Int. Cl. B66F 11/00; B66F 15/00

(52) U.S. Cl. CPC B66F 11/00; B66F 15/00
USPC 254/8 R

(57) ABSTRACT

A one-man operable hot water heater lifting device. An inner lifter arm is pivotally connected to an extendable extension arm. A pivot stabilizer arm is connected between the inner lifter arm and the inner extension arm. A plurality of outer lifter arms are connected to the inner lifter arm. A plurality of wheels is pivotally connected to the lifting device. The outer lifter arms are connected to the hot water heater and the hot water heater is lifted by pressing downward on the outer extension arm.

The present invention relates to lifting devices, and in particular, to lifting devices for hot water heaters. This application claims the benefit of Provisional Application No. 61/826,305 filed May 22, 2013, which is incorporated by reference herein.

### BACKGROUND OF THE INVENTION

Nearly every household in modern society utilizes a hot water heater to provide hot water. Hot water heaters are very heavy. A 50 gallon hot water heater can weight 150 lbs., empty. Hot water heaters can be expected to last between 6-9 years on average before a replacement is needed. Because hot water heaters are very heavy, large, cumbersome, and often elevated on a stand or platform it can be extremely difficult for one man or even two men to properly install the heater. Injury to installers is very common and very costly.

What is needed is a better lifting device for hot water heaters.

### SUMMARY OF THE INVENTION

The present invention provides a one-man operable hot water heater lifting device. An inner lifter arm is pivotally connected to an extendable extension arm. A pivot stabilizer arm is connected between the inner lifter arm and the inner extension arm. A plurality of outer lifter arms are connected to the inner lifter arm. A plurality of wheels is pivotally connected to the lifting device. The outer lifter arms are connected to the hot water heater and the hot water heater is lifted by pressing downward on the outer extension arm.

### BRIEF DESCRIPTION OF THE DRAWINGS

FIG. 1 shows a preferred embodiment of the present invention.

FIGS. 2A and 2B show a preferred hot water heater wrapped with a strap.

FIGS. 3-6 show details on wrapping a preferred hot water heater.

FIGS. 7-9 show a preferred method of using the present invention.

FIGS. 10-17 show a preferred method for disassembling and then reassembling the lifting device for easy transport and storage.

FIGS. 18-21 show another preferred embodiment of the present invention.

FIG. 22 shows another preferred embodiment of the present invention.

### DETAILED DESCRIPTION OF THE PREFERRED EMBODIMENTS

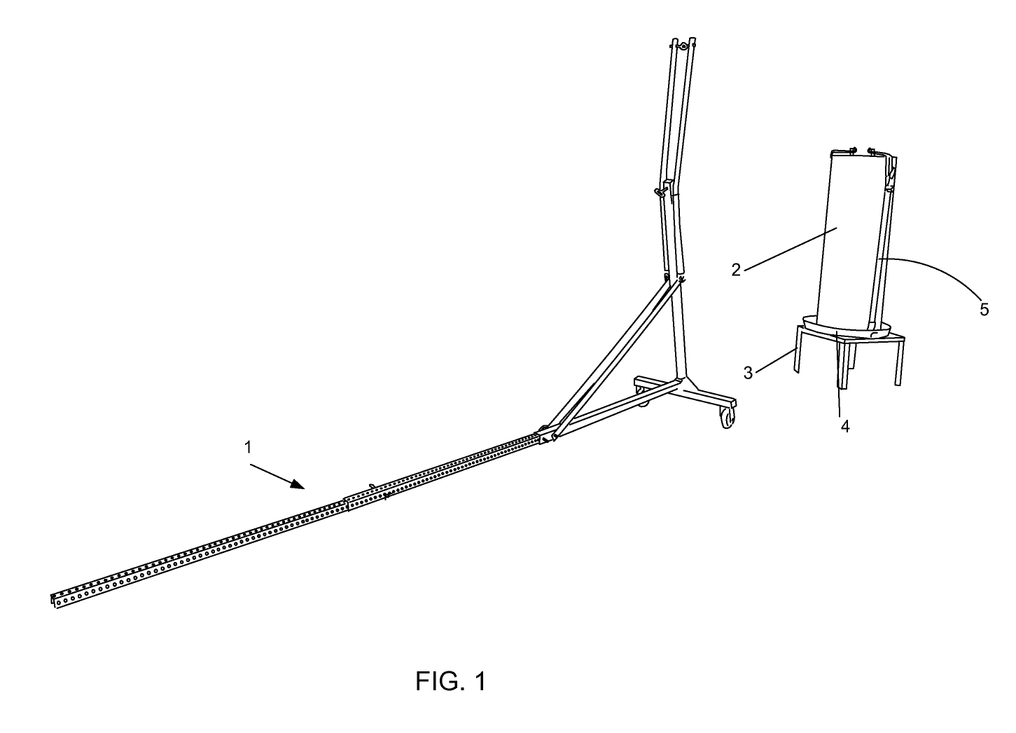

FIG. 1 shows a preferred embodiment of the present invention. One-man operated lifter 1 is utilized to lift hot water heater 2 onto elevated platform 3. In the embodiment shown in FIG. 1, pan 4 sits on top of table 3 and lifter 1 is able to lift heater 2 over the top edge of pan 4 so that heater 2 is placed inside pan 4. Preferably, lifter 1 is fabricated from lightweight, strong aluminum and weighs approximately 65 pounds.

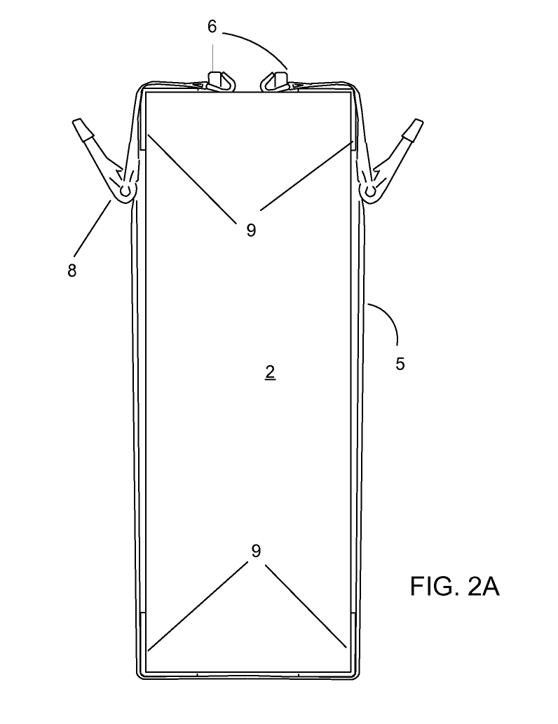

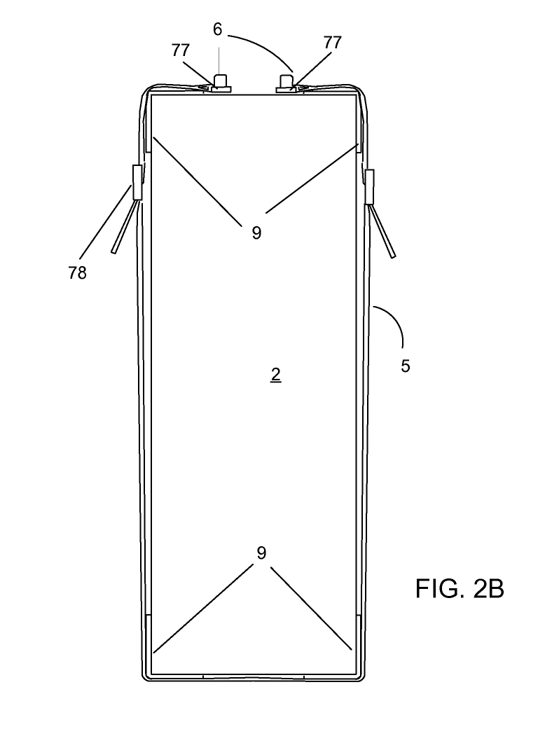

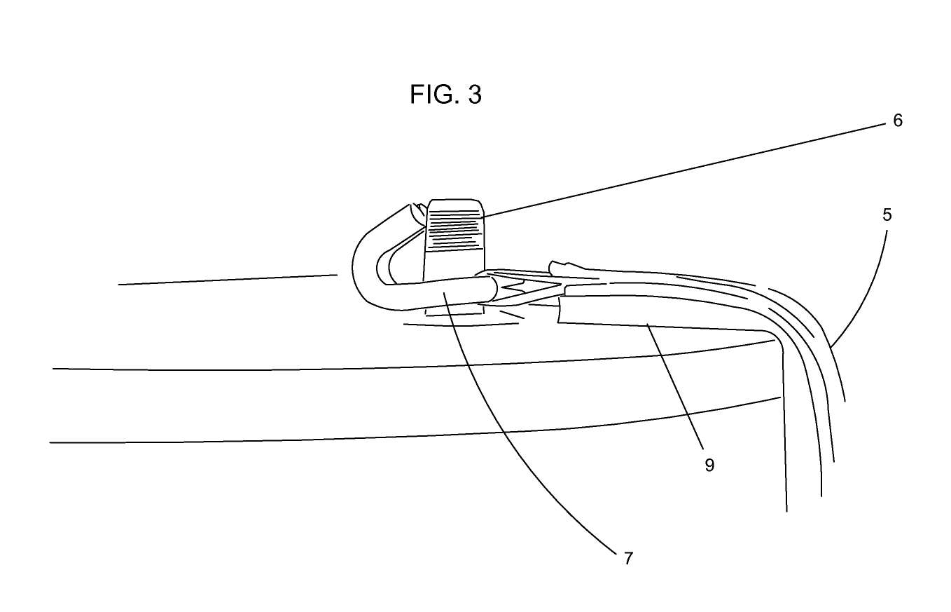

Prior to lifting heater 2, strap 5 is wrapped around heater 2 as shown. FIG. 2A shows further details of strap 5 as it is wrapped around heater 2. Protective pads 9 are placed underneath strap 5 to protect heater 2. The ends of strap 5 are looped around water heater pipe nipples 6 (see also FIG. 3) utilizing hooks 7. Ratchet 8 is utilized to tighten strap 5 securely around heater 2 (see also FIG. 4).

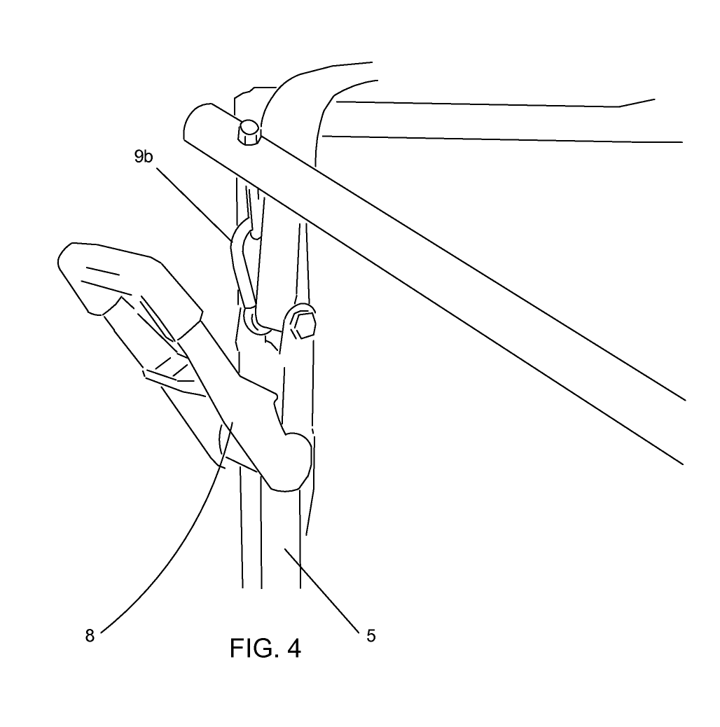

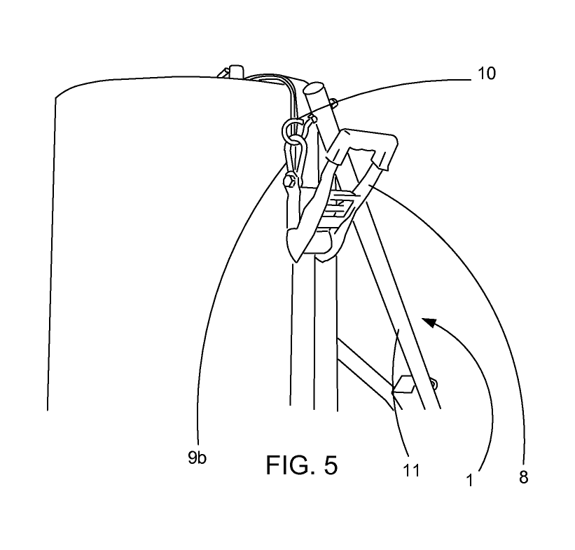

After strap 5 is secured around heater 2, lifter 1 is connected to rings 9b of strap 5 (FIG. 5). FIG. 5 shows ring 9b connected to strap 5. Ring 9b connects to loop 10 of lifter 1 as shown. FIG. 6 shows a front view of inner lifter arm 14, outer lifting arm holding tubes 11b. Outer lifting arms 11 are slid into outer lifting arm connector tubes 11b and are connected to straps 5 of heater 2.

### Lifting the Heater

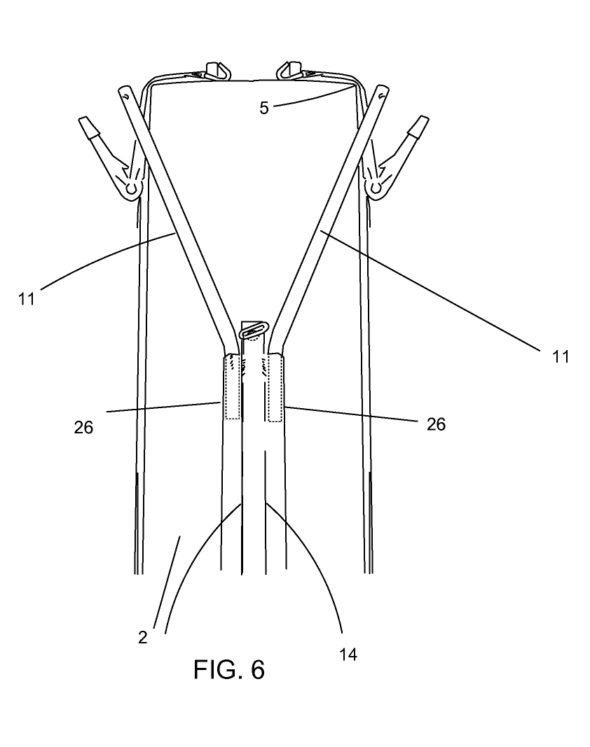

In FIG. 7 the user has pressed downward on outer extension arm 12C of lifter 1 to cause heater 2 to be lifted. Pivot stabilizer arms 13 are shown connected to inner extension arm 12b. In one preferred embodiment the distance from the far end of outer extension arm 12C to wheels 15 is approximately 11 feet, the distance from wheels 15 to the far ends of outer lifting arms 11 is approximately 5½ feet. Connecting arms 13 preferably hold inner lifter arm 14 and inner extension arm 12b separated at an angle of approximately 110-125 degrees.

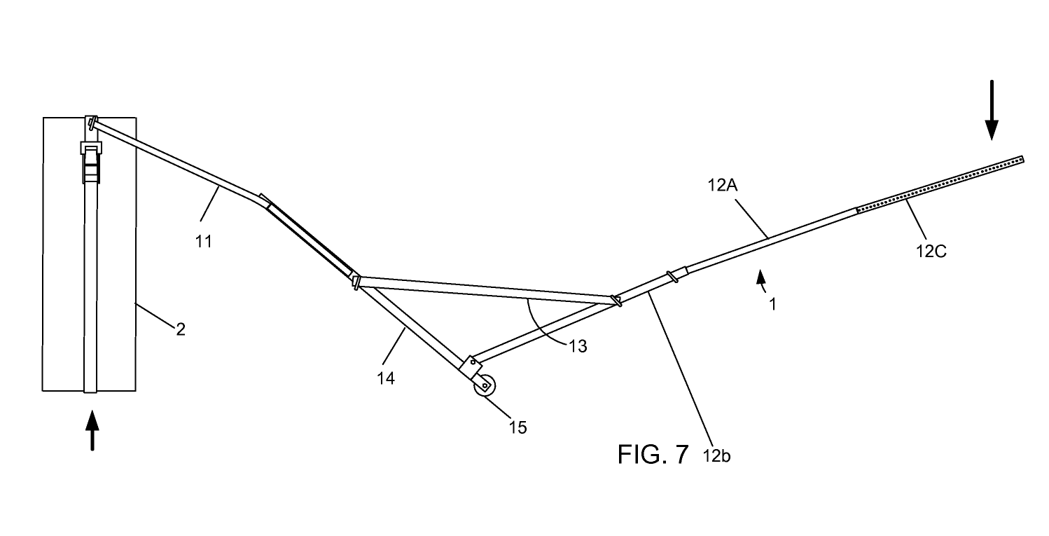

FIG. 8 shows pivot stabilizer arms 13 connected to inner extension arm 12b and inner lifter arm 14. Pivot stabilizer arms 13 hold inner lifter arm 14 rigid at a preferred angle for lifting, as shown in FIG. 8.

Lifting arms 11 are lifting heater 2 off the ground (FIG. 8). The user has pushed lifter 1 towards table 3 and lifter 1 has rolled towards table 3 on wheels 15. Heater 2 is positioned above pan 4 on table 3.

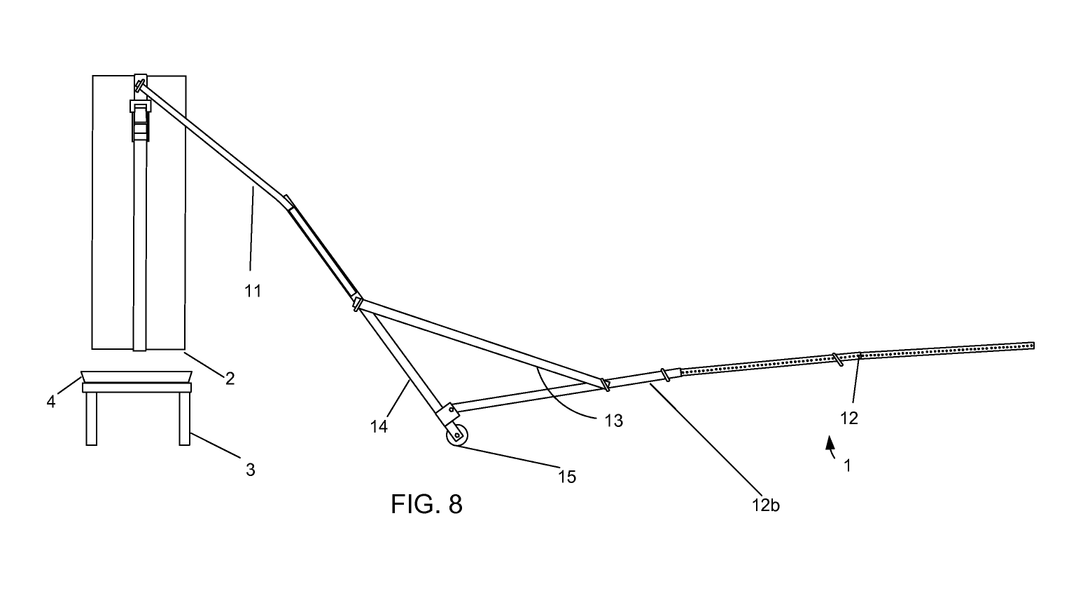

In FIG. 9 the user has eased up downward force on outer extension arm 12C which has caused heater 2 to be lowered into pan 4 on table 3. Heater 2 is now in the correct position on table 3 inside pan 4. The user now will disconnect lifter 1 from straps 5 and then remove straps 5 from heater 2.

### Disassembling the Lifter for Easy Storage and Transport

After heater 2 has been installed the user will need to disassemble lifter 1 so that he can easily roll it to his vehicle, place it inside the vehicle and transport it to the next job location.

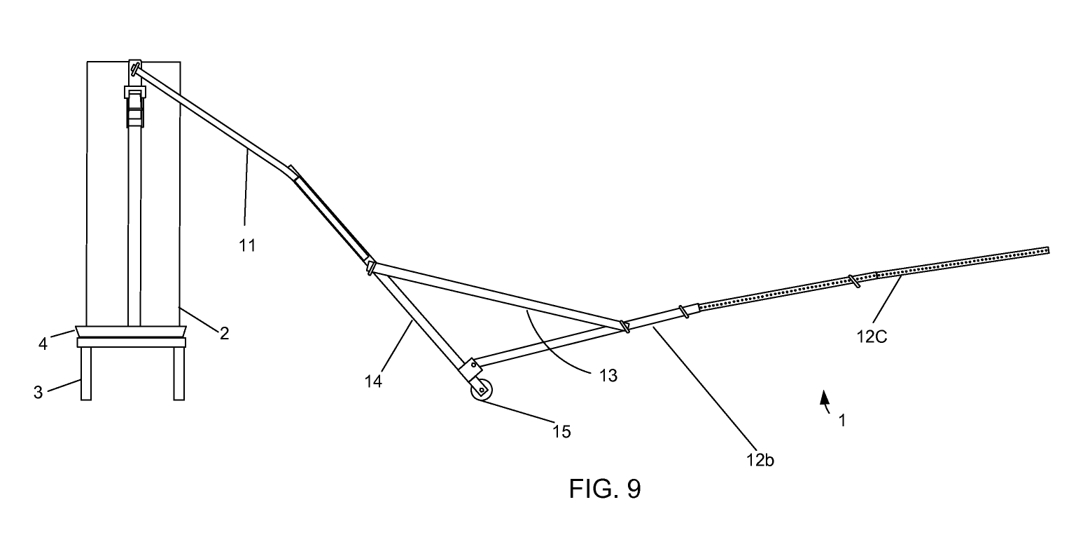

In FIG. 10, the user has removed outer lifter arms 11 from outer lifter arm connector tubes 26 and has set them aside.

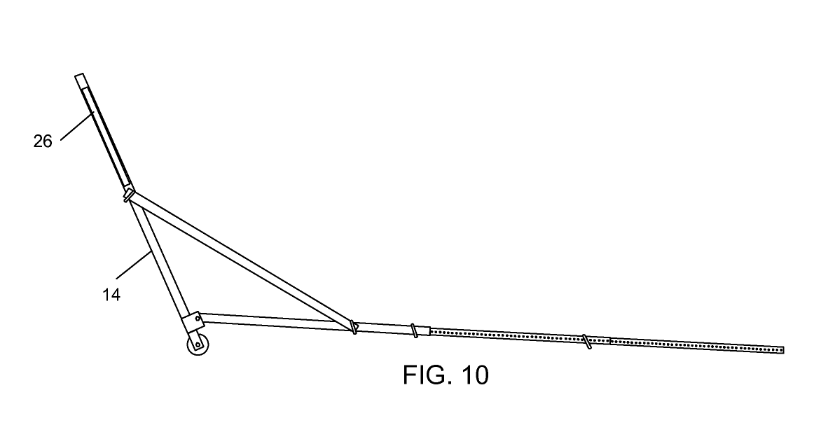

In FIG. 11 the user has disconnected inner lifter arm 14 from pivot stabilizer arms 13 by removing connector pins. The user has positioned inner lifter arm 14 on the ground as shown.

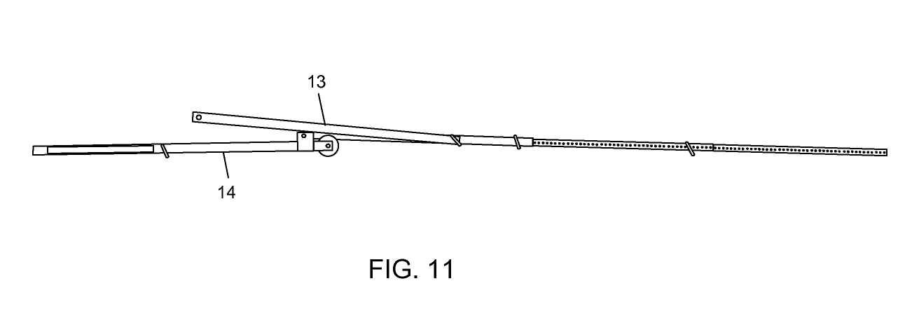

In FIG. 12 the user has disconnected inner extension arm 12b from pivot stabilizer arms 13 by removing connector pins. The user has positioned inner extension arm 12b on the ground as shown and has set pivot stabilizer arms 13 aside.

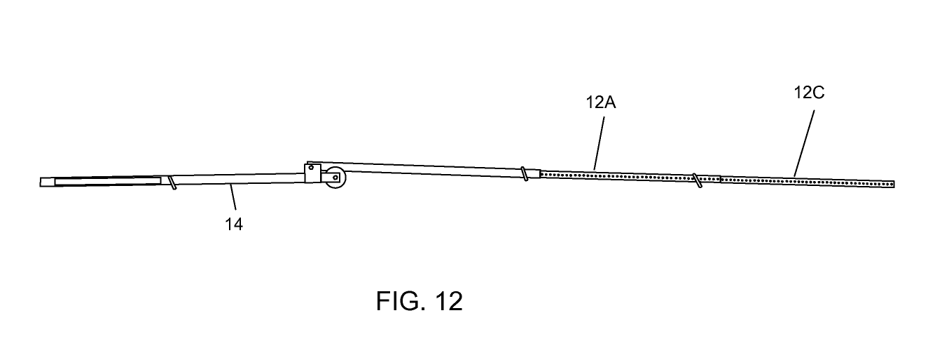

In FIG. 13, the user has removed the connector pin that holds middle extension arm 12A and outer extension arm 12C in an extended position attached to inner extension arm 12b. The user is pushing middle extension arms 12A and outer extension arm 12C inside inner extension arm 12b for storage.

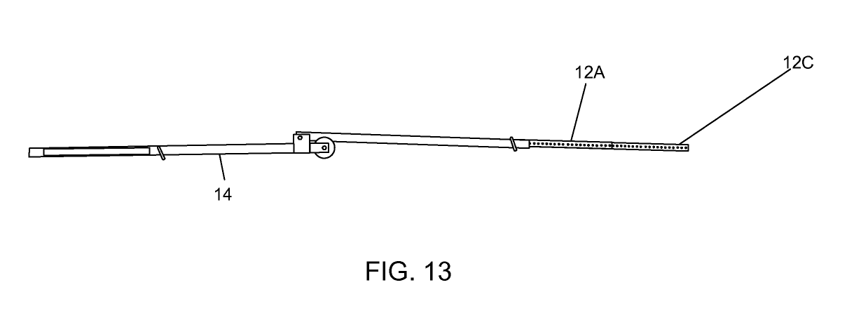

In FIG. 14 the user has pivoted pivotally attached inner extension arm 12b so that it is lying on top of inner lifter arm 14. The user has inserted connector pin 93 to secure inner extension arm 12b to inner lifter arm 14.

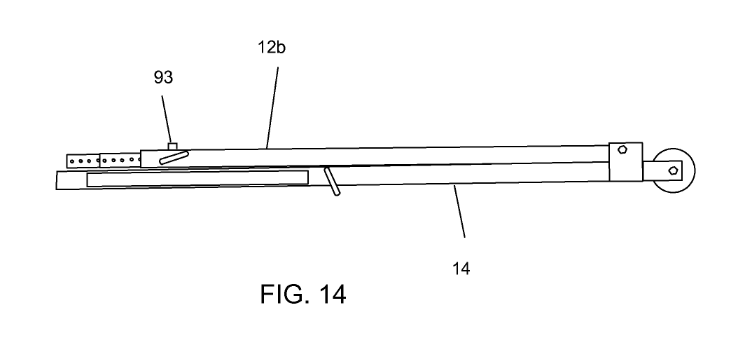

In FIG. 15 the user has inserted outer lifter arms 11 into connector tubes 26 of inner lifter arm 14. Outer lifter arms 11 are held in place by connector pins 94. Outer lifter arms 11 allow for lifter 1 to be stored upright as shown.

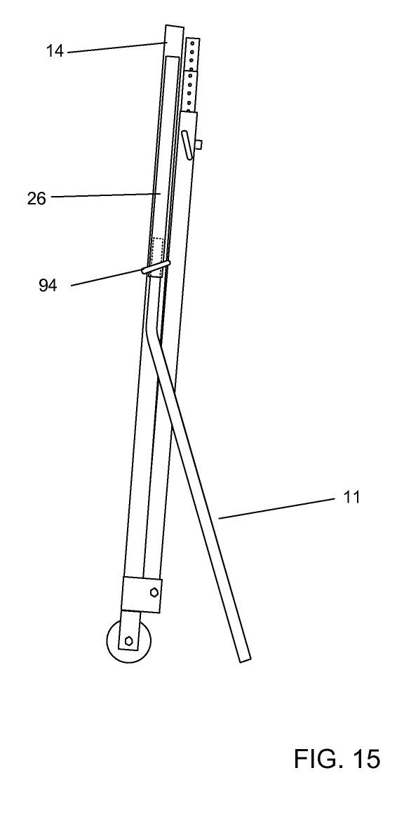

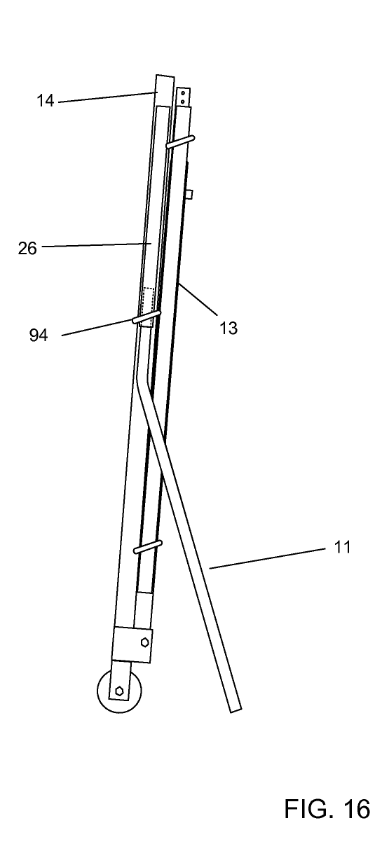

In FIGS. 16 and 17 the user has connected pivot stabilizer arms 13 to inner extension arm 12b by using connector pins 95. FIG. 17 shows lifter 1 fully disassembled and then reassembled so that it is ready for easy transport. The user can now easily roll lifter 1 to his vehicle for storage and transport.

### Other Preferred Embodiment

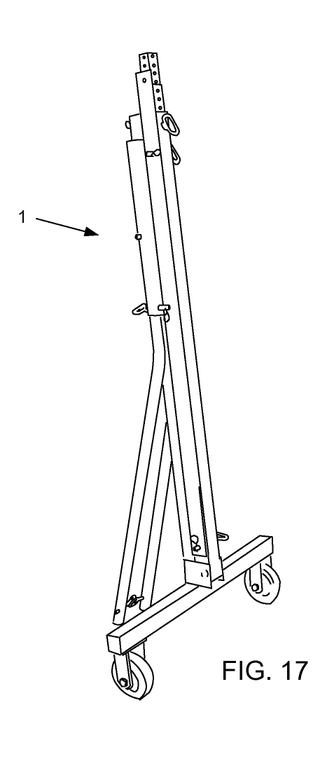

FIG. 18 shows another preferred embodiment of the present invention. For lifter 100, inner extension arm 52b is pivotally connected to inner lifter arm 102. Outer extension arms 11 are inserted into outer lifter arm tubes 102A and 102B, as shown.

Lifter 100 includes pivot stabilizer arm 101. Pivot stabilizer arm 101 is preferably a flexible cable that is threaded through holes in inner lifter arm 102 and connected to connection pins 105.

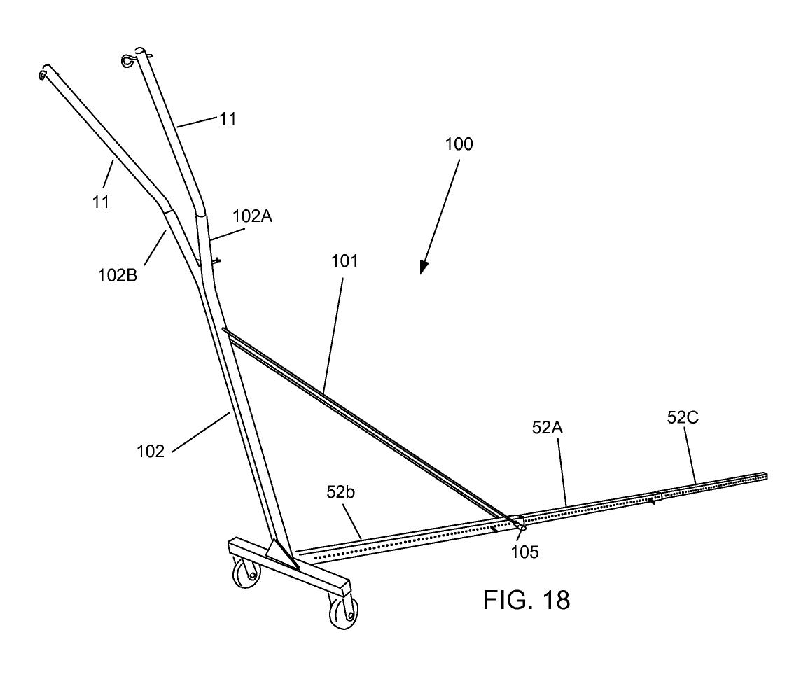

Flexible cable 101 allows for easier assembly and disassembly of lifter 100. For example, in FIG. 19 the user has removed outer lifter arms 11 and has pinned them to inner lifter arm 102. Outer lifter arms 11 hold lifter 100 upright as shown.

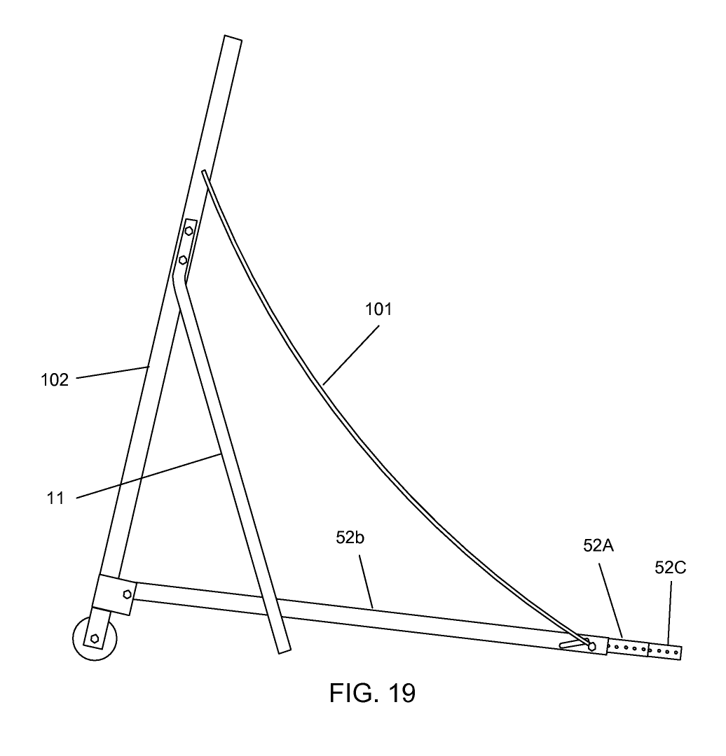

In FIG. 20 the user has pivoted inner extension arm 52b upward and has pinned it to inner lifter arm 102 Likewise the user has clasped pivot stabilizer arm 101 to inner extension arm 52b as shown. Lifter 100 is now ready to me transported and stored.

### Other Preferred Embodiment

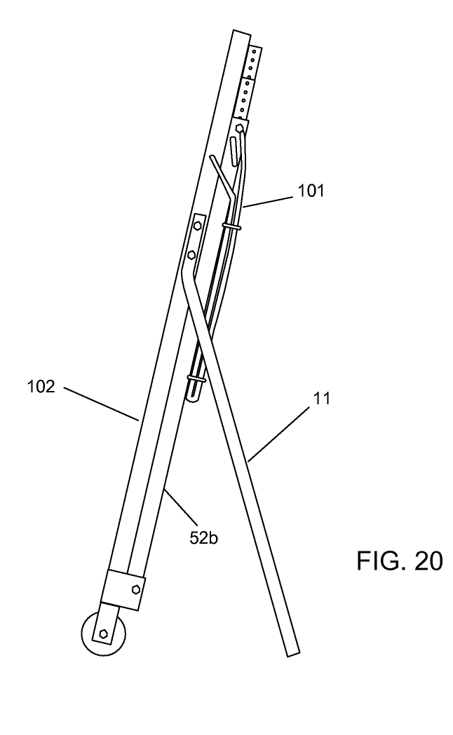

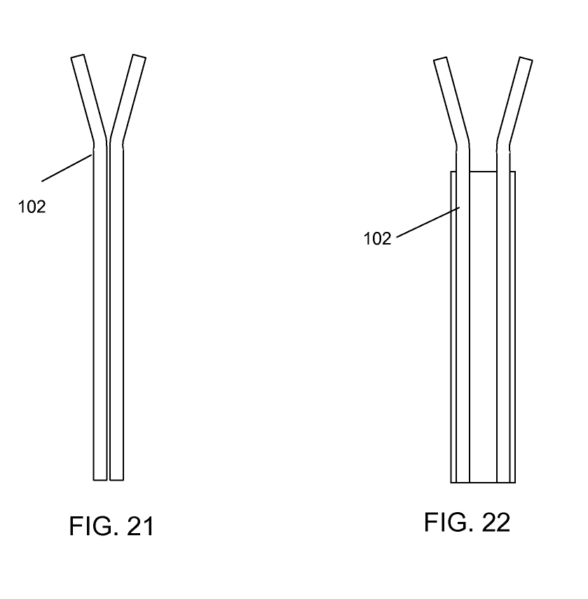

FIG. 22 shows another preferred embodiment of the present invention. In FIG. 22 inner lifter arms 102 have been separated by approximately 8 inches. This allows for greater separation of outer lifter arms 11 which is important when lifting very large hot water heaters. FIG. 21 shows closer separation of inner lifter arms 102 similar to that depicted in FIG. 18.

Although the above-preferred embodiments have been described with specificity, persons skilled in this art will recognize that many changes to the specific embodiments disclosed above could be made without departing from the spirit of the invention. For example, it is possible to use rings 77 in place of hooks 7. It is also possible to substitute cam buckles 78 for ratchets 8 (see FIG. 2B). Therefore, the attached claims and their legal equivalents should determine the scope of the invention.

What is Claimed is:

1. A one-man operable hot water heater lifting device, comprising:
A) an inner lifter arm,
B) an extendable extension arm pivotally connected to said inner lifter arm,
C) at least one pivot stabilizer arm connected between said inner lifter arm and said extendable extension arm,
D) a plurality of outer lifter arms connected to said inner lifter arm, and
E) a plurality of wheels pivotally connected to said lifting device,
wherein said outer lifter arms are connected to said hot water heater, wherein said hot water heater is lifted by pressing downward on said outer extension arm.

2. The hot water heater lifting device as in claim 1, wherein said hot water heater comprises:
A) two extensions extending upwards from the top of said hot water heater,
B) a strap connected wrapped around said hot water heater and connected to said two extensions via connection hooks,
C) at least one ratchet connected to said strap, and
D) a plurality of connection rings connected to said strap,
wherein said outer lifter arms are connected to said strap via said connection rings.

3. The hot water heater lifting device as in claim 2 wherein said ratchet is a cam buckle.

4. The hot water heater lifting device as in claim 1, wherein said lifting device is collapsible and transportable.

5. The hot water heater lifting device as in claim 3, wherein said lifting device is collapsible and transportable by:
A) collapsing said extendable extension arm,
B) pivoting said extendable extension arm so that it lies adjacent to said inner lifter arm, and
C) connecting said extendable extension arm to said inner lifter arm.

6. The hot water heater lifting device as in claim 1, wherein said lifting device is fabricated from aluminum.

7. The hot water heater lifting device as in claim 1, further comprising a plurality of outer lifter arm connector tubes rigidly connected to said inner lifter arm.

8. The hot water heater lifting device as in claim 1, wherein said pivot stabilizer arm is a flexible cable.

9. The hot water heater lifting device as in claim 1, wherein said extendable extension arm comprises:
A) an inner extension arm pivotally connected to said inner lifter arm,
B) a middle extension arm connected to said inner extension arm, and
C) an outer extension arm connected to said middle extension arm.
